(19) United States
(12) Patent Application Publication
(10) Pub. No.: US 2003/0217191 A1
(43) Pub. Date: Nov. 20, 2003

(54) System and method for converting the UI logic of a windows software application to run within a web browser

(76) Inventors: Yang Gao, Fremont, CA (US); Shun Gao, Fremont, CA (US); Zheng John Shi, Fremont, CA (US); Armeen Mazda, Tiburon, CA (US)

Correspondence Address: Armeen Mazda, Shell Electric Mfg. Co. Ltd., 1/F, Shell Industrial Building, 12 Lee Chung Street, Chai Wan District, CN

(21) Appl. No.: 10/147,897

(22) Filed: May 20, 2002

(51) Int. Cl. G06F 9/00

(52) U.S. Cl. 709/320; 709/329

(57) ABSTRACT

The present invention provides a system and method for converting the UI logic of a Windows software application to run within a Web browser. The system provides means for creating properties and functions for an HTML UI control type. These functions and properties are made similar to the functions and properties of a UI control type utilized in the Windows software application. The UI logic of the Windows software application is then translated into JavaScript, such that the UI logic utilizes the newly created functions and properties. Reduction in material differences between the two sets of UI logic reduces the complexity and time re UI ed for translation of the UI logic code. The present invention provides further economic benefits with repeated use.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates generally to the migration of existing computer software systems, and more particularly to a system and method for converting the UI (user interface) logic of a Windows software application to run within a Web browser.

2. Description of the Related Art

Over the last 10 years, nearly all enterprises have made significant investment in development of Windows software applications. Many of these Windows software applications are in the form of 4GL client/server applications. This popularity in 4GL client/server applications is attributed to two key benefits, ease of development and superior end-user experience.

Today, with the emergence of the Web and Java or Microsoft's .NET as the dominant enterprise-computing medium, transforming enterprise 4GL client/server applications into HTML applications has become imperative. The n-tier architecture of HTML applications offers tremendous economic benefits to the enterprise, such as expanding reach of critical applications and reducing total cost of ownership (TCO). Together with either Java or Microsoft's NET, HTML applications have emerged as the solution for standardizing the currently complex and heterogeneous enterprise-computing environment.

However, the plethora of 4GL client/server applications in existence today cannot be simply migrated or transformed into HTML applications. This is due to the fact that the architecture of HTML applications is fundamentally different from that of 4GL client/server applications. These differences and their significance become apparent upon examining the presentation layer's workings. Specifically, these differences manifest themselves in three key ingredients of the presentation layer: the UI controls that end-users interact with; the UI logic that manipulates these UI controls; and the protocol used to communicate with the business logic layer.

The 4GL client/server application's presentation layer is deployed as a relatively thick but powerful client to an operating system, usually Microsoft Windows. 4GL supports many powerful UI controls, such as the Grid, Tree View, and Menu controls, in addition to many standard UI controls. These controls provide for efficient input and output of information. A hefty chunk of UI logic resides at the client. Many advanced UI t-in functions, properties, and events are supported by 4GL such that powerful UI logic can be implemented, making complex UI behaviors possible. Via procedure calls (i.e. either local or remote procedure calls), the presentation and business logic layers are able to communicate repeatedly while a given Window process is running. By default, 4GL client/server applications offer a complex and interactive UI (i.e. GUT) that is operated through one or more Windows. Thus, 4GL is best UI ed for delivering a software application UI.

The HTML application's presentation layer is deployed as a relatively thin client with limited functionality to a Web browser. HTML supports only a relatively simple and basic set of UI controls, such as the checkbox, drop-down list, and textbox controls. For certain input or output tasks, these HTML UI controls greatly compromise efficiency. Typically, very little UI logic (JavaScript) resides at the client (HTML page). The functionality of the UI logic is constrained by the fewer and less advanced UI t-in functions, properties, and events supported by standard Web browsers. Consequently, only relatively simple UI behaviors can be implemented, such as validating an HTML form before submission. The presentation and business logic layers communicate over the stateless HTTP (Hyper Text Transfer Protocol) by submitting HTML forms and generating Web pages. A new Web page process must be started before new information can be delivered to the Web browser and displayed, which manifests itself as either a page refresh or the loading of a new HTML page. By default, HTML applications offer a simple and static UI (i.e. HTML UI) that mandates the request, generation, and delivery of numerous Web pages for a most UI operations. Thus, HTML is best UI ed for presenting relatively static information or documents.

The dramatic difference between the 4GL client/server application's architecture and that of HTML applications has forced enterprises to rewrite their 4GL client/server applications from the ground up. A new design must be implemented that fits into the constraints of the HTML page and Web browser. This design must take into account the lack of advanced UI controls, do away with robust UI logic at the client, and break the application workflow into snapshots for a given process such that a given process can be delivered via pages and HTML. This re-design is further complicated by the fact that a whole host of new issues must be dealt with when UI ding HTML applications, such as maintaining session/state over the stateless HTTP, implementing a Web security model, and so on.

The biggest drawback of this approach is the significant investment re UI ed. Practically speaking, most of the original investment to UI d the original 4GL client/server application is lost. Since the new HTML application design represents a large departure from the 4GL client/server application design, little of the original design can be reused, all presentation layer source code must be junked, and the business logic layer must undergo an overhaul. Weak tools further complicate development and lengthen the project cycle time. The premature Web RAD tools available today fail in comparison to traditional 4GL RAD tools. When compared to traditional 4GL RAD tools, Web RAD tools lack the high level of code abstraction and powerful pre-built application objects. Thus, the time and money re UI ed to UI d the HTML application typically approaches that needed to originally develop the 4GL client/server application.

Another drawback of this approach is loss of a powerful Windows GUI. This loss yields an application UI that is unfamiliar and slower. As a result, the end-user must face a new learning curve and generally end up working slower. Moving from a desktop email program to a Web-based email program serves as an example that many can relate to. Transitioning to the HTML UI is not seamless, and even relatively simple email tasks, such as moving an email from one folder to another can consume significant time. The inferior HTML UI therefore poses an organizational risk and cost burden. It disrupts current business processes, imposes retraining costs, and compromises end-user productivity.

From the discussion above, it should be apparent that there is a need for an improved method of migrating a Windows software application, such as a 4GL client/server application, to run within a Web browser. More specifically, there is a need for an improved method of converting the UI logic of a Windows software application into the UI logic of an HTML application. It is advantageous to the extent that the functionality of the original UI logic can be replicated. The present invention fulfills this need.

### BRIEF SUMMARY OF THE INVENTION

To overcome the shortcomings of the prior art described above, it is an object of the present invention to provide a method for converting the UI logic of a Windows software application into the UI logic of an HTML application.

It is another object of the present invention to provide a method for creating properties and functions of an HTML UI control.

Accordingly, there is provided, in a first form, a method for converting the UI logic of a Windows software application to run within a Web browser. The method includes the step of creating a set of HTML UI controls with functions and properties similar to the functions and properties of UI controls utilized in the Windows software application. The creation step includes the sub-step of providing means to instantiate JavaScript non-visual objects that can be used to act upon the functions and properties of the HTML UI controls. The method also includes the step of converting the UI logic of the Windows software application into JavaScript UI logic of an HTML application such that the non-visual objects are utilized.

Additionally, there is also provided, in a second form, a method for implementing UI logic to act upon a UI control displayed in a Web browser. The method includes the step of defining a class of objects with a JavaScript constructor function, wherein the JavaScript constructor function defines functions and/or properties of an HTML UI control type. The method also includes the step of instantiating a JavaScript non-visual object of the class to act upon a HTML UI control of the HTML UI control type. The method also includes the step of using the non-visual object to act upon the functions and/or properties of the HTML UI control.

An advantage of the present invention is the reduction in the time and effort re UI ed to migrate a Windows software application to the Web.

Another advantage of the present invention is the reduction of material differences between portions of the UI logic that act upon UI controls of a Windows software application and portions of the UI logic that act upon UI controls of an HTML application.

The above, as well as additional objects, features and advantages of the present invention will become apparent in the following detailed written description.

### BRIEF DESCRIPTION OF THE SEVERAL VIEWS OF THE DRAWING

FIG. 1 illustrates a typical networked computer system that is UI able for practicing the preferred embodiment of the present invention; and

FIG. 2 is a block diagram that illustrates a software system UI able for practicing the preferred embodiment of the present invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural and functional changes may be made without departing from the scope of the present invention.

Overview

The present invention discloses a method for converting the UI logic of a Windows software application to run within a Web browser. The key aim of this method is to reconcile material differences between the portions of the UI logic that acts upon UI controls of a Windows software application and portions of the UI logic that acts upon UI controls of an HTML application. Due to the limitations of HTML, facilitating this reconciliation re UI es a new approach for implementing UI logic in an HTML application. One key aim of such new approach is to provide a flexible and scalable means for creating new properties and functions of a given HTML UI control type. Needless to say, bridging such material difference between the two sets of UI logic simplifies the UI logic conversion task.

Hardware Environment

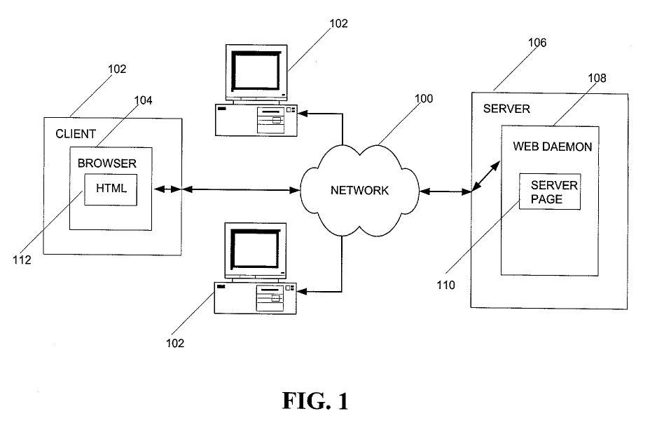

FIG. 1 schematically illustrates the hardware environment of the preferred embodiment of the present invention, and more particularly, illustrates a typical distributed computer system using the Internet 100 to connect client systems 102 executing Web browsers 104 to server systems 106 executing Web daemons 108. A typical combination of resources may include clients 102 that are personal computers or workstations, and servers 106 that are personal computers, workstations, minicomputers, or mainframes. These systems are coupled to one another over a network 100, which may include other networks such as LANs, WANs, SNA networks, as well as the Internet.

Server page 110 is requested from Web daemon 108, downloaded to client systems 102, and ultimately executed within Web browsers 104 as HTML page 112. HTML page 112 is composed of HTML and JavaScript. Those skilled in the art will recognize that other file formats and programming languages could be used at either Web browser 104 or Web daemon 108 without departing from the scope of the present invention.

In general, the HTML page 112 when read and executed by the Web browser 104 causes the Web browser 104 to perform the steps for performing and/or using the present invention. Generally, the data and/or instructions are embodied in and/or readable from a device, carrier or media, such as memory, data storage devices, and/or remote devices coupled to the computer via a data communications device.

However, those skilled in the art will recognize that the exemplary environment illustrated in FIG. 1 is not intended to limit the present invention. Indeed, those skilled in the art will recognize that other alternative hardware environments may be used without departing from the scope of the present invention.

Thus, the present invention may be implemented as a method, apparatus, or article of manufacture using standard programming and/or engineering techniques to produce software, hardware, firmware, or any combination thereof. In addition, the term “article of manufacture” as used herein is intended to encompass logic and/or data embodied in or accessible from any device, carrier, or media.

Operation of the Invention

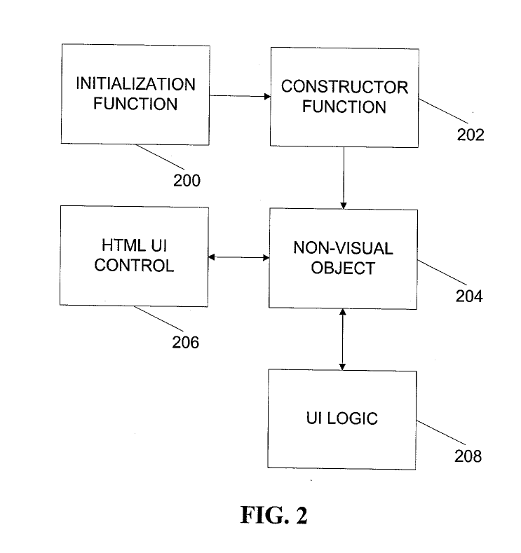

FIG. 2 is a block diagram that illustrates a software system that is UI able for practicing the preferred embodiment of the present invention, and more particularly, illustrates critical pieces embedded into HTML page 112 to enable the present invention. The system consists of a first HTML UI control 206, a first JavaScript constructor function 202, and a first initialization function 200. The HTML UI control 206 is the browser-based representation of a first UI control used in a Windows software application. The JavaScript constructor function 202 represents a class of objects, which defines the properties and methods of HTML UI control 206. Note that the JavaScript constructor function 202 is not the same as the concept of constructor functions in other object-oriented programming languages such as C++. The initialization function 200 uses the JavaScript constructor function 202 to instantiate a non-visual object 204 that will be associated with HTML UI control 206. Non-visual object 204 inherits the properties and methods defined by the JavaScript constructor function 202. These properties and methods are utilized by UI logic 208 to act upon HTML UI control 206 via non-visual object 204.

Converting the UI logic of a Windows software application to operate within the software system disclosed in FIG. 2 re UI es three tasks, implementing HTML UI controls, implementing JavaScript constructor functions, and generating the UI logic for the HTML application. An HTML UI control is implemented for each UI control utilized in the Windows software application. A JavaScript constructor function is implemented for each HTML UI control type utilized in the HTML application. The properties and functions of the HTML UI control type are defined in a corresponding JavaScript constructor function. These properties and functions are made similar in terms of functionality and usage to their Windows' counterparts. The UI logic of the Windows software application is converted into the UI logic the HTML application, wherein the UI logic of the HTML application is written in JavaScript instructions and utilizes the software system disclosed in FIG. 2.

HTML UI Control

The design of the HTML UI control is crucial to the type of UI logic actions that can be replicated within the Web browser. The HTML UI control may be as simple as a single HTML element, such as a HTML button, or as complex as several HTML elements driven by specialized logic. Regardless of its complexity, the functions and properties of the HTML UI control are implemented as instructions that make use of the browser-supported properties, methods, and behaviors of the UI control's HTML element(s). So care must be taken when implementing the HTML UI control such that the HTML element(s) is capable of replicating the properties and functions associated with the UI control of the Windows software application. A first recommended practice is to group the HTML elements that comprise an HTML UI control within a container. For more complex HTML UI controls, many of its properties and functions will need to act upon more than one of the HTML elements comprising the UI control. These HTML element(s) can be grouped within a container that renders HTML, such as the <DIV>tag as implemented by Microsoft Web browsers or the <LAYER>tag as implemented by Netscape Web browsers. This practice simplifies the coding of most properties or functions that act upon the HTML UI control. For example, a complex HTML UI control that is comprised of several HTML textboxes could be hidden simply in one command by setting its <DIV>or <LAYER>tag's VISIBILITY property to HIDDEN.

A second recommended practice is to assign structured IDs to the HTML UI Control's container and HTML element(s). The properties and functions of the HTML UI control will act upon the control's container or its HTML element(s); thus the container and its element(s) need to be referenced. IDs will need to be assigned to the HTML UI control's container and element(s), and it is beneficial to have a systematic approach for naming these IDs. The preferred naming convention of the present invention identifies the type and instance of the HTML UI control and the type and instance of the HTML tag. Using a Command Button control as an example, the prefix “DIV_CB_” plus a non-visual object reference “btnl” could be used as the ID for the container, and the prefix “CB_” plus a non-visual object reference “btnl” could be used as the ID for the HTML element. This practice simplifies the coding task and organizes the referencing of a HTML UI control's container and element(s).

In one embodiment of the present invention, the HTML code utilized to implement the HTML UI control may be set forth as follows:

<DIV id=”containerIdName” name=”containerIdName”>
<INPUT id=”elementIdName” name=”elementIdName”
type=“inputType”>
</DIV>

It should be noted that “containerldName” is the id of the HTML UI control's container. It should be noted that “elementIdName” is the id of the HTML UI control's element. It should be noted that “inputType” is the input HTML element's type, such as checkbox.

JavaScript Constructor Function

The JavaScript constructor function represents a class of objects that instantiates non-visual objects capable of acting upon HTML UI controls of a given type. To enable this, the JavaScript constructor function must accomplish several tasks. It associates the non-visual object with its corresponding HTML UI control. It provides a set of properties that define characteristics of a given HTML UI control such that the characteristics of these properties can be readily modified. It provides a set of methods that act upon a given HTML UI control. Due to the nature of these three tasks, it is best to specialize a JavaScript constructor function for a given HTML UI control type.

A first recommended practice is to store references to the HTML UI control's container and element(s) within the non-visual object. The HTML UI control needs to be referenced when its properties and functions are executed. Sometimes it may be necessary to act upon the HTML UI control's container, and other times it may be necessary to act upon one or more of its elements. By assigning the HTML UI control's container and element(s) references to properties of the non-visual object, these references can be stored within the non-visual object. This practice simplifies the coding task for referencing the HTML UI control's container and element(s) and is generally regarded as a good programming practice.

A second recommended practice is to read and change the value of the properties of HTML UI controls through methods of their non-visual objects. To modify a characteristic of an HTML UI control's property, it will be necessary to apply some logic to properties of the HTML UI control's container and/or element(s). Quite often, this logic can comprise several lines or more. The logic should be packaged within a function, which should be implemented as a method of the non-visual object. This practice simplifies manageability of these functions and is generally regarded as a good programming practice.

A third recommended practice is to implement functions that act upon a HTML UI control as methods of its non-visual object. As already mentioned, implementing functions as methods of the non-visual object is a good programming practice.

In one embodiment of the present invention, the JavaScript code used to implement the JavaScript constructor function may be set forth as follows:

function constructorFunctionName(objectName)

{
//Initializes the property and assigns a null value.

this.m_oContainer = null;

//Initializes the property and assigns a null value.

this.m_oHost = null;

//Defines the method used to store references for the HTML UI control within

the object.
this.create = function(objectName)
{

//Stores the object name in the property.

this.m_objectName = objectName;

//Constructs the container's reference and assigns to the
variable.

var m_oContainer = eval(“window.” + “containerPrefix” +
objectName);

//Assigns the container's reference to the property.

this.m_oContainer = m_oContainer;

//Constructs the element's reference and assigns to the variable.

var m_oElement = eval(“window.” + “elementPrefix” +
objectName);

//Assigns the element's reference to the property.

this.m_oHost = m_oElement;

//Creates the alias for the non-visual object so it can be
referenced without the window prefix.

eval(“window.” + objectName + “ = this;”);

//Returns a Boolean value of true if the process completed
successfully.

return true;

}

//Creates the setProperty method and defines the properties of the HTML UI

control.
this.setProperty = function (property, value)
{

switch (property)
{

//Defines a property and the instructions to set the value
of the property.

case “propertyName” :

//Instructions for this property go here.

break;

//Additional properties can be created here.

default:
break;

}

}

//Creates the getProperty method and defines the properties of the HTML UI

control.
this.getProperty = function (property)
{

//Initializes the variable value.
var value = null;
switch (property)
{

//Defines a property and the institutions to get the value

of the property.

case “propertyName” :

//Instructions for this property go here.

break;

//Additional properties can be created here.

default:
break;

}

//Returns the value obtained from the property.

return value;

}

//Creates a method of the object and defines a function of the HTML UI

control.
this.methodName = function ( )
{

//Instructions for this method go here.

}

//Additional methods can be created here.
//Executes the create method to associate the HTML UI control with the

object.
this.create(objectName);

}

It should be noted that “constructorFunctionName” is the function name of the JavaScript constructor function. It should be noted that “objectName” is a parameter, of “constructorFunctionName” function, that holds the object reference name used to instantiate the non-visual object. It should be noted that “containerPrefix” is a string that indicates the prefix used in the ID of the HTML UI control's container. It should be noted that “elementprefix” is a string that indicates the prefix used in the ID of the HTML UI Control's element. It should be noted that “property” is a parameter, of the “getProperty” and “setProperty” functions, that holds the property name to be operated on. It should be noted that “value” is a parameter, of the “getProperty” and “setProperty” functions, that holds a property's value. It should be noted that “propertyName” is a string that indicates the name for a specified characteristic of the HTML UI control. It should be noted that “methodName” is a string that indicates the method name for executing a specified function of the HTML UI control.

Initialization Function

The initialization function instantiates the various non-visual objects associated with various HTML UI controls through their respective JavaScript constructor functions. Within the initialization function are commands that call the JavaScript constructor function and pass necessary parameter(s) (i.e. at least the object reference name) to instantiate various non-visual objects. A non-visual object should be instantiated for each HTML UI control that is used in the Web page. Lastly, the non-visual object should be instantiated before any UI logic is executed.

In one embodiment of the present invention, the JavaScript code used to implement the initialization function may be set forth as follows:

function _Eon_Initialize( )
{
//Creates a new object of the class object type.

new constructorFunctionName(objectName);

// Additional object instantiations are created here.
}

It should be noted that “constructorFunctionName” is the function name of the JavaScript constructor function that is to be used to instantiate the non-visual object for a given HTML UI control. It should be noted that “objectName” is a string that indicates the object reference name of the non-visual object.

In one embodiment of the present invention, the JavaScript code utilized to call the “_Eon_Initialize” function may be set forth as follows:

//Calls the initialization function once the Web page has loaded. window.onload=_Eon_Initialize;

UI Logic

UI logic acts upon HTML UI controls through the functions of their corresponding non-visual objects. Two specialized functions, getProperty and setProperty, are used to read and change the value of the HTML UI control's properties. Functions of the HTML UI control are executed as methods of the non-visual object. The properties and functions of the HTML UI control can have the same names and accept the same set of arguments as the properties and functions of the UI control in the Windows software application.

In one embodiment of the present invention, the JavaScript code utilized to call the “getproperty” function may be set forth as follows:

objectName.getProperty(propName);

It should be noted that “objectName” is an object reference that indicates the non-visual object for the HTML UI control to act upon. It should be noted that “propName” is a string that indicates the property whose value will be retrieved.

In one embodiment of the present invention, the JavaScript code utilized to call the “setproperty” function may be set forth as follows:

obj ectName.setProperty(propName, propvalue);

It should be noted that “objectName” is an object reference that indicates the non-visual object for the HTML UI control to act upon. It should be noted that “propName” is a string that indicates the property whose value will be changed. It should be noted that “propValue” is a variant (e.g. string, integer) that indicates the new value to be assigned to the specified property.

In one embodiment of the present invention, the JavaScript code utilized to call a function of an HTML UI control may be set forth as follows:

objectName.methodName( );

It should be noted that “objectName” is an object reference that indicates the non-visual object for the HTML UI control to act upon. It should be noted that “methodName” is a method name that indicates the method to be executed. It should be noted that the method might re UI e any number of parameters.

Migration Process

Before the actual migration of UI logic source code can begin, a set of HTML UI control types and JavaScript constructor functions must be created. The properties and functions of the HTML UI control types that are defined by within these JavaScript constructor functions should be similar in terms of functionality and usage to the properties and functions of the UI control types utilized by the Windows software application. Thus the following two guidelines should be followed to ensure such similarity. First, the properties of a given HTML UI control type should be close in number to its counterpart in the Windows software application. Each defined property should be identical in characteristic (e.g. specifies height of the control), and work with the same set of values (e.g. an integer—the height in pixels). Second, the functions of a given HTML UI control type should be close in number to its counterpart in the Windows software application. Each defined function should be identical in the task it performs (e.g. relocate a UI control), and work with the same set of arguments (e.g. two integers—specifies the x and y coordinates in pixels) and return values (e.g. a Boolean—whether the operation succeeded or failed). To the extent that such a similar set of HTML UI control types can be created, less work will be involved in the UI logic migration and more of the original UI functionality may be preserved.

When it is not possible to recreate a property or function of a given UI control type of the Windows software application within the HTML application, sacrifice must be made. There are essentially two options, either to eliminate usage of the property or function, or to devise some workaround. Each option has its implications, so their pros and cons should be carefully evaluated on a case-by-case basis. Eliminating usage of a property or function from the UI logic may deprive the application of a needed UI functionality. On the other hand, this is the fastest way of bridging the difference so that the UI logic can be migrated and become fully functional. A workaround will nearly always re UI e the use of additional technologies, such as ActiveX, Java Applets, or browser plug-ins. In addition to the investment required to develop the workaround, each of these technologies have their own shortcomings. On the other hand, a workaround may preserve a needed UI functionality.

With the appropriate set of HTML UI control types in place, the UI logic migration becomes rather straightforward and mechanical. There are five tasks that should be completed. First task, generate a mapping to correspond the properties and functions of the UI control types of the Windows software application to the properties and functions of the HTML UI control types of the HTML application. Second task, for each UI control in the Windows software application, include the corresponding HTML UI control and respective JavaScript constructor function in the HTML application. Third task, for each HTML UI control, instantiate its non-visual object via a corresponding JavaScript constructor function during run-time of the HTML application. Fourth task, based on the mapping, convert instructions that act upon properties of the UI controls in the Windows software application into JavaScript instructions that utilize the appropriate method (i.e. “getProperty” or “setProperty”) of the non-visual objects. Fifth task, based on the mapping, convert instructions that act upon functions of the UI controls in the Windows software application into JavaScript instructions that execute the corresponding methods of the non-visual objects. Once these five tasks have been completed, the remaining work is largely straight translation of the remaining UI logic of the Windows software application into JavaScript.

Migration Example

Take a hypothetical Command Button control in a Windows software application. This Command Button control is defined to have one property named TEXT, which retrieves and sets the text displayed on the button, and one function named MOVE, which relocates the button to a new location on the screen.

Several lines of UI logic are written that act upon this Command Button control. The purpose of the UI logic is to store the current text displayed (in a variable), make the button display a new message (i.e. “Clicked”), and relocate it to a new position on the screen (i.e. 15, 20). The following source code represents the example UI logic to be migrated:

string saveText_btnl=btnl.text

btnl.text=“Clicked”

btnl.move(15, 20)

Prior to translating this UI logic into JavaScript, the HTML UI, JavaScript constructor function, and initialization function need to be defined:

One example of the code used to implement the Command Button HTML UI control is provided below:

<div id=“DIV_CB_btn1” name=“DIV_CB_btn1”>
<input id=“CB_btn1” name=“CB_btn1” type=“button”
value=“Click Me!” >
</div>

One example of the code used to implement the Command Button JavaScript constructor function is provided below:

function CommandButton(objectName)

{
//Initializes the property and assigns a null value.

this.m_oContainer = null;

//Initializes the property and assigns a null value.

this.m_oHost = null;

//Defines the method used to store references to the CommandButton within

the object.
this.create = function(objectName)
{

//Stores the object name in the property.

this.m_objectName = objectName;

//Constructs the container's reference and assigns to the
variable.

var m_oContainer = eval(“window.DIV_CB_“ +
objectName);

//Assigns the container's reference to the property.

this.m_oContainer = m_oContainer;

//Constructs the element's reference and assigns to the variable.

var m_oElement = eval(“window.CB_” + objectName);

//Assigns the element's reference to the property.

this.m_oHost = m_oElement;

//Creates the alias for the non-visual object so it can be
referenced without the window prefix.

eval(“window.” + objectName + “ = this;”);

//Returns a Boolean value of true if the process completed

successfully.

return true;

}
//Creates the setProperty method and defines the properties of the

CommandButton.
this.setProperty = function (property, value)
{

switch (property)
{

//Defines a property to set the text of the

CommandButton.

case “text” :

//Sets the CommandButton's text via the

element's value property.

this.m_oHost.value=value;

break;
default :
break;

}

}

//Creates the getProperty method and defines the properties of the Command

Button.
this.getProperty = function (property)
{

//Initializes the variable value.

var value = null;
switch (property)
{

//Defines a property to retrieve the text of the

CommandButton.

case “text” :

//Obtains the CommandButton's text via the

element's value property.

value = this.m_oHost.value;

break;
default :
break;

}

//Returns the value obtained from the property.

return value;

}

//Creates a move method of the object that relocates the CommandButton to

the specified x and y coordinates.
this.move = function (x,y)
{

//Converts the string value of parameter x into an integer.

x = parseInt(x);

//Converts the string value of parameter y into an integer.

y = parseInt(y);

//If x is not a number then CommandButton is set to the default x
position.

if(!x)x = 0;

//If y is not a number then the CommandButton is set to the default y
position.

if(!y) y = 0;

//Moves the CommandButton via the container's posLeft property to the

new x position.

this.m_oContainer.style.posLeft = x;

//Moves the CommandButton via the container's posTop property to the

new y position.

this.m_oContainer.style.posTop = y; }

//Executes the create method to associate the CommandButton with the object.

this.create(objectName);

}

One example of the code used to implement the initialization function and initialize the Command Button HTML UI control is provided below:

function _Eon_Initialize( )
{
//Creates a new btn1 object of CommandButton type.

new CommandButton(“btn1”);

}
//Calls the initialization function once the Web page has loaded.

window.onload = _Eon_Initialize;

Now that the HTML UI control's properties and functions are ready for use, the UI logic can be translated into JavaScript, such that the UI logic can run within a Web browser. According to the objective of the present invention, the following UI logic of the HTML application is functionally identical and the syntax is similar to the UI logic of the Windows software application:

//Get the text property of the CommandButton btn1 and store in the
variable.

saveText_btn1 = btn1.getProperty(“text”);

//Set the text property of the CommandButton btn1 to “Clicked.”

btn1.setProperty(“text”, “Clicked”);

//Move CommandButton btn1 to 15, 20.

btn1.move(15, 20);

Conclusion

One key feature of the present invention is that the properties and functions of the HTML UI controls are represented through non-visual objects. This feature has two basic points of differentiation from current practices. First, this feature enables object oriented programming of UI logic, wherein UI logic is written to act upon objects rather than individual HTML tags. Second, this feature enables new UI control properties and functions to be created for a given HTML UI control type. Thus, any (new or migrated) HTML application that has either relatively complex HTML UI controls or complex UI logic will benefit from this disclosed method of the present invention.

A second key feature of the present invention is that UI control types utilized in the HTML application are made equivalent to their counterparts in the Windows software application. This equivalency results in HTML UI control types are similar in terms of their properties and functions. This similarity minimizes the material differences between the UI logic of an HTML application and the UI logic of a Windows software application. Minimizing these material differences reduces complexity in migration of the UI logic.

The present invention is best suited for migrating Windows software applications that have the same programming characteristics. If the Windows software applications have been built with the same system objects and the same programming language, the HTML UI control types and logical map developed for a first migration can be leveraged by subsequent migrations. Thus the present invention delivers maximum benefits with repeated use.

While the present invention has been particularly shown and described with reference to the preferred embodiments, it will be understood by those skilled in the art that various changes in form and detail may be made without departing from the spirit, scope and teaching of the invention. Accordingly, the disclosed invention is to be considered merely as illustrative and limited in scope only as specified in the appended claims.

We claim:

1. A method for implementing UI logic to act upon a UI control displayed within a Web browser, comprising the steps of:
defining a first class of objects, wherein the class defines a first function and/or a first property of a first HTML UI control type;
instantiating a first non-visual object of said first class, wherein the non-visual object is associated with a first HTML UI control of said first HTML UI control type; and
acting upon said first function and/or said first property of said first HTML UI control of said first HTML UI control type by said first non-visual object.

2. The method of claim 1, wherein the definition of said first class, instantiation of said first non-visual object, and action upon said first function and/or said first property are written in a scripting programming language that is capable of running within a Web browser.

3. The method of claim 1, wherein said first HTML UI control is comprised of a first HTML <input> tag.

4. The method of claim 1, wherein the HTML element(s) comprising said first HTML UI control are contained within a first HTML <div></div>container.

5. The method of claim 1, wherein said first class is a subclass.

6. The method of claim 1, wherein a first reference to said first HTML UI control is stored within a property of said first non-visual object.

7. The method of claim 1, wherein a first method of said non-visual object is used to act upon said first property of said HTML UI control.

8. The method of claim 7, wherein the value returned by said first method is derived from the value of a first property of a first HTML element comprising said first HTML UI control.

9. The method of claim 7, wherein the value of a first property of a first HTML element comprising said first HTML UI control is derived from the value passed as a first argument of said first method.

10. The method of claim 1, wherein a first method of said first non-visual object executes said first function of said HTML UI control.

11. The method of claim 11, wherein said first method of said first non-visual object acts upon a first property of said first HTML UI control.

30. A method for implementing UI logic to act upon a UI Control displayed within a Web browser, comprising the steps of:
defining a first object constructor, wherein the object constructor defines a first function and/or a first property of a first HTML UI control type;
instantiating a first non-visual object using said first object constructor, wherein the non-visual object is associated with a first HTML UI control of said first HTML UI control type; and
acting upon said first function and/or said first property of said first HTML UI control of said first HTML UI control type by said first non-visual object.

31. The method of claim 30, wherein the definition of said first object constructor, instantiation of said first non-visual object, and action upon said first function and/or said first property are written in a scripting programming language that is capable of running within a Web browser.

32. The method of claim 30, wherein said first HTML UI control is comprised of a first HTML <input> tag.

33. The method of claim 30, wherein the HTML element(s) comprising said first HTML UI control are contained within a first HTML <div></div>container.

34. The method of claim 30, wherein a prototype object of said first object constructor is used in defining said first function and/or said first property of said HTML UI control type.

35. The method of claim 30, wherein a first reference to said first HTML UI control is stored within a property of said first non-visual object.

36. The method of claim 30, wherein a first method of said non-visual object is used to act upon said first property of said HTML UI control.

37. The method of claim 36, wherein the value returned by said first method is derived from the value of a first property of a first HTML element comprising said first HTML UI control.

38. The method of claim 36, wherein the value of a first property of a first HTML element comprising said first HTML UI control is derived from the value passed as a first argument of said first method.

39. The method of claim 30, wherein a first method of said first non-visual object executes said first function of said first HTML UI control.

40. The method of claims 39, wherein said first method of said first non-visual object acts upon a first property of said first HTML UI control.

60. A method for converting the UI logic of a Windows software application to run within a Web browser, comprising the steps of:
creating a first counterpart of a first property and/or first function of a first UI control type of the said Windows software application for a first HTML UI control type; and
converting a first line of instruction utilizing the first property and/or said first function of said Windows software application into a second line of instruction utilizing said counterpart, wherein the second line of instruction is capable of running within a Web browser.

61. The method of claim 60, wherein said second line of instruction is written in a scripting programming language.

62. The method of claim 60, wherein said counterpart is a property of said first HTML UI control type that defines the same characteristic as said first property of said first UI control type of said Windows software application.

63. The method of claim 60, wherein said counterpart is a property of said first HTML UI control type that has the same property name as said first property of said first UI control type of the said Windows software application.

64. The method of claim 60, wherein said counterpart is a function of said first HTML UI control type that is functionally similar to said first function of said first UI control type of said Windows software application.

65. The method of claim 64, wherein a first argument of said function of said first HTML UI control type is the same as a first argument of said first function of said first UI control type of said Windows software application.

66. The method of claim 60, wherein said counterpart is a function of said first HTML UI control type that has the same function name as the said first function of said first UI control type of said Windows software application.

67. The method of claim 60, wherein said counterpart is utilized via a method of a first non-visual object associated with a first HTML UI control of said first HTML UI control type.

68. The method of claim 60, wherein the association between said counterpart and said first property or said first function of said first UI control type of said Windows software application is expressed in a computer readable format.

69. The method of claim 68, wherein said computer readable format is XML.

90. A system for implementing UI logic to act upon a UI Control displayed within a Web browser, comprising:
means for defining a first class of objects, wherein the class defines a first function and/or a first property of a first HTML UI control type;
means for instantiating a first non-visual object of said first class, wherein the non-visual object is associated with a first HTML UI control of said first HTML UI control type; and
means for acting upon said first function and/or said first property of said first HTML UI control of said first HTML UI control type by said first non-visual object.

91. The system of claim 90, wherein a first value is obtained from said first property of said HTML UI control via a method of said non-visual object.

92. The system of claim 90, wherein a first value is assigned to said first property of said HTML UI control via a method of said non-visual object.

93. The system of claim 90, further comprising means for associating said HTML UI control with said non-visual object.

94. The system of claim 93, wherein a first reference to said HTML UI control is assigned to a property of said non-visual object.
